(19) United States
(12) Patent Application Publication
(10) Pub. No.: US 2023/0342375 A1
(43) Pub. Date: Oct. 26, 2023

(54) Extension for Third Party Provider Data Access

(71) Applicant: Microsoft Technology Licensing, LLC, Redmond, WA (US)

(72) Inventor: Robert Peter Damore II, Redmond, WA (US)

(21) Appl. No.: 17/725,249

(22) Filed: Apr. 20, 2022

(51) Int. Cl. G06F 16/25

(52) U.S. Cl. CPC G06F 16/258

(57) ABSTRACT

A computer implemented method includes receiving a first request for data to be retrieved from a first provider of multiple providers. A first provider definition data structure is identified. The first request is then formatted in accordance with the first provider definition data structure to generate a first formatted request. The first formatted request is sent to the first provider and a first response is received from the first provider.

### BACKGROUND

Data providers may each require different ways that clients must request data. Existing application programming interfaces (APIs) of web clients can be used to search, browse, and page through third party data or content, which may include images, videos, audio, and other data. The existing APIS client devices unify all third-party content results into a single response structure so that clients can build against a single structure while getting content from many different sources. The problem is that the APIs use a significant amount of data provider-specific code to achieve the unification. In some cases, up to 20 files containing hundreds of lines of code are used to support each new provider.

### SUMMARY

A computer implemented method includes receiving a first request for data to be retrieved from a first provider of multiple providers. A first provider definition data structure is identified. The first request is then formatted in accordance with the first provider definition data structure to generate a first formatted request. The first formatted request is sent to the first provider and a first response is received from the first provider.

### BRIEF DESCRIPTION OF THE DRAWINGS

FIG. 1 is a block diagram of a system for searching multiple service providers that have different interfaces for providing access to data according to an example embodiment.

FIG. 2 is a diagram showing a search request for “apples” corresponding to the search generated by a user device according to an example: embodiment.

FIGS. 3A, 3B, 3C, 3D, 3E, 3F, and 3G placed end to end are a diagram illustrating an example response according to an example embodiment.

FIG. 4 is a flowchart illustrating a computer implemented method of using provider definitions while searching disparate data sources according to an example embodiment.

FIG. 5 is a block schematic diagram of a computer system to implement one or more example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software in one embodiment. The software may consist of computer executable: instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media, Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

A significant amount of third party provider code may be required in order for a web client of a client device to request data from multiple third party providers, Each new third-party provider requires more provider-specific code for supporting the provider.

A web application programming interface (API) extension in a web client enables the web client to search and browse across any third-party provider without the need for any new provider-specific code. The extension may also be used in place of existing provider specific code used by the web client.

The extension works by obtaining a provider specific definition as input to the API extension of the web client. The provider definition may be passed in by the client at runtime or can be stored in a configuration (config) setting in the client or provider.

The provider definition may be structured data such as a data interchange format containing information about the provider attribution, API endpoints, response parsing details, and more. A JSON (JavaScript Object Notation) may be used for the structured data. Using information in the structured data, the extension can formulate a request to the third-party provider API to either search, browse, or page through various types of content. The extension may also be used to parse the provider response into the same unified response structure the web API provides today, but without all the provider-specific code.

The structured data defines how the web API extension should formulate a request for data from each third-party provider, and what information should be parsed back to the client.

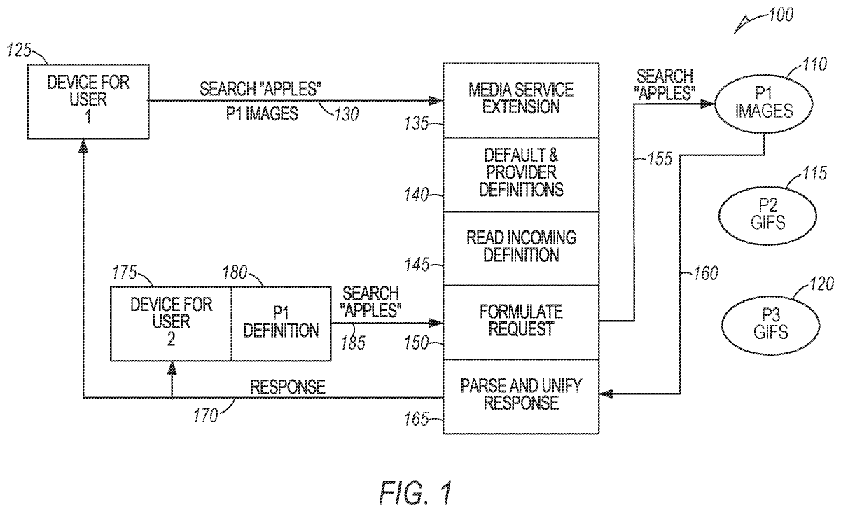

FIG. 1 is a block diagram of a system 100 for searching multiple service providers P1 110, P2 115, P3 120 that have different interfaces for providing access to data. In various examples, P1 110 may be an image database, such as PING, P2 115 may be a GIF database such as TENOR, and P3 may be another GIF database such as GIPHY. Further service providers with even further types of data may be included in further examples.

Users may utilize a web client, such as a browser to generate requests for data from the service providers. In one example a client device 125 may generate a search request 130 for images from service provider PI 110 using a search term such as “apples.” The search request 130 may be made using the web client that sends the search request to a media service 135. In one example, the search request includes both a search phrase and one or more services providers to be searched. The search request may also include the type of content or data requested, such as images,

The request 130 from client device 125 may have the following format:

```
“parameters”: {
  “gp”: “Tenor”
},
“pageSize”: 5,
“descriptor”: {
  “$type”: “GenericSearchDescriptor”
},
“query”: “apples”
```

The provider, Tenor, is described along with a page size of 5 and a query term or key of “apples.” The search type is a generic search descriptor.

The media service 135 may include multiple provider definitions 140 for use in properly formatting the request 130. The provider definitions 140 are data structures that equate fields of a provider API to fields in media service 135, Such fields may include a content type, such as image, a page size parameter, page offset parameter and others as described in further detail below. The provider definitions 140 may be used by an extension that reads the incoming definition 145 and formulates at 150, a formatted request 155. The formatted request 155 is formatted specifically for the intended service provider, such as P1 110, and is sent to P1 110 at 155 as shown. (Please provide an example formatted request corresponding to the above search request)

In one example, the provider definitions 140 specify formatting for a response 160 that will be sent back to the client device 125. By specifying the formatting for the response 160 from each different provider, responses from different providers will include consistent information which can be parsed to generate a unified response at a parser 165. Fields of the response may be identified and correlated by using the P1 provider definition in conjunction with the default provider definition to provide a unified response 170 to client device 125.

In a further example, a second client device 175 may include a provider definition 180 for P1 and may append the provider definition to a search for “cats” 185. The search 185 may be provided directly to 150 for formulating the request 155. Responses from P1 110 may be processed in the same manner to provide response 170 to client device 175. Multiple requests to multiple different providers may be combined by parser 165 to provide a uniform response 170 format allowing a uniform treatment and display of information parsed and displayed back to the client.

Client devices running web clients may generate searches intended for more than one service provider in a further example. Each request will be processed using a corresponding service provider definition for each of the intended service provider. Results from each service provider will be parsed and unified by parser 165 and provided back to the requesting client. The results may be sorted as desired, such as by date, relevancy, service provider, or other parameter as desired.

A service provider definition may be expressed as a data interchange format such as JSON or XML. An example JSON service provider definition for Tenor, an image database is as follows, with actual hyperlinks replaced with descriptive language:

```
{
  “provider_name”: “Tenor”,
  “provider_attribution”: “Powered by Tenor”,
  “provider_tos”: “hyperlink to tenor legal terms”,
  “search_endpoint”: “ hyperlink to tenor search”,
  “browse_endpoint”: “ hyperlink to tenor trending”,
  “content_type”: “image”,
  “page_size_parameter”: “limit”,
  “page_offset_parameter”: “pos”,
  “query_parameter”: “q”,
  “other_query_parameters”: [
  “locale”,
  “ar_range”,
  “contentfilter”
  ],
  “api_key”: {
  “query_parameter”; “key”,
  “key”: “{TenorApiKey}”
  },
  “generic_response_parsing”: {
  “content_root”: “results”,
  “next”: “next”,
  “id”: “id”,
  “description”: “content_description”,
  “source_page_url”: “”,
  “full_res_content”: {
  “url”: “media[0].gif.url”,
  “width”: “media[0].gif.dims[0]”,
  “height”: “media[0].gif.dims[1]”,
  “content_size”: “media[0].gif.size”
  },
  “thumbnail”: {
  “url”: “media[0].gif.url”,
  “width”: “media[0].gif.dims[0]”,
  “height”: “media[0].gif.dims[1]”,
  “content_size”: “media[0].gif.size”
  }
  }
  }
```

The provider definition data structure has a format that specifies a media service 135 name for a field followed by the service provider equivalent. For example, provider-name is identified as Tenor. The next field is provider_attribution identified as “Powered by Tenor.” The attribution may be included with each result provided in response 170 to give proper attribution of the result as being from the Tenor service provider. Many other fields may be specified to both identify searching and provider endpoints, content type, parameters for page size, page offset, query parameters, locale, and how to specify search terms or keys. In one example, page size in Tenor is a “limit.” A placeholder may be used instead of a key if desired.

In one example, different providers may provide thumbnail images in many different formats and sizes. Provider responses may also use different names for fields of data.

A second part of the provider definition specifies how to parse replies from the service provider. The second part need not be included in the request 155. The second part of the provider definition may be used by the parser 165 to format the replies for sending the response 170 to the client device. The second part of the provider definition begins with generic_response_parsing and includes fields for use by parser 165 to equate description of the content returned, url, dimensions for display, and thumbnail specifications including width and height of thumbnails to ensure the response 170 is formatted similarly for content from multiple providers, Such similar formatting may be described as a unified response.

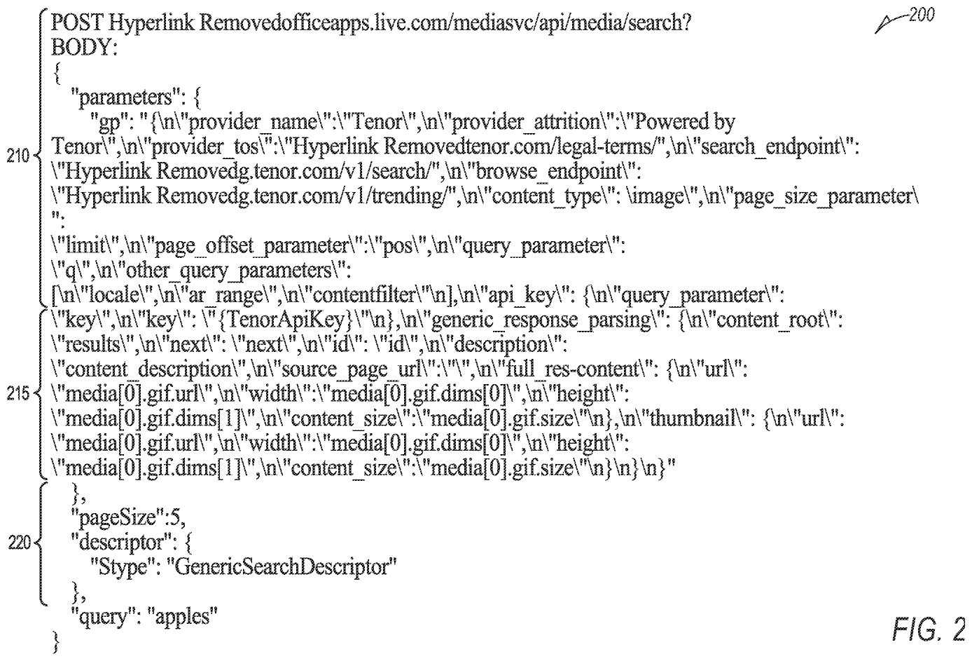

FIG. 2 is a diagram showing a search request 200 for “apples” corresponding to the search 185 generated by user device 175. Search request 200 is similar to the above search request, but also includes the provider definition. A first portion of the provider definition is indicated at 210. The first portion 210 includes the endpoint for interfacing with the desired service provider, Tenor and the content type of images. A second portion of the provider definition includes the response parsing at 215 beginning at “generic_response_parsing.” A search phrase for “apples” is also shown at 220.

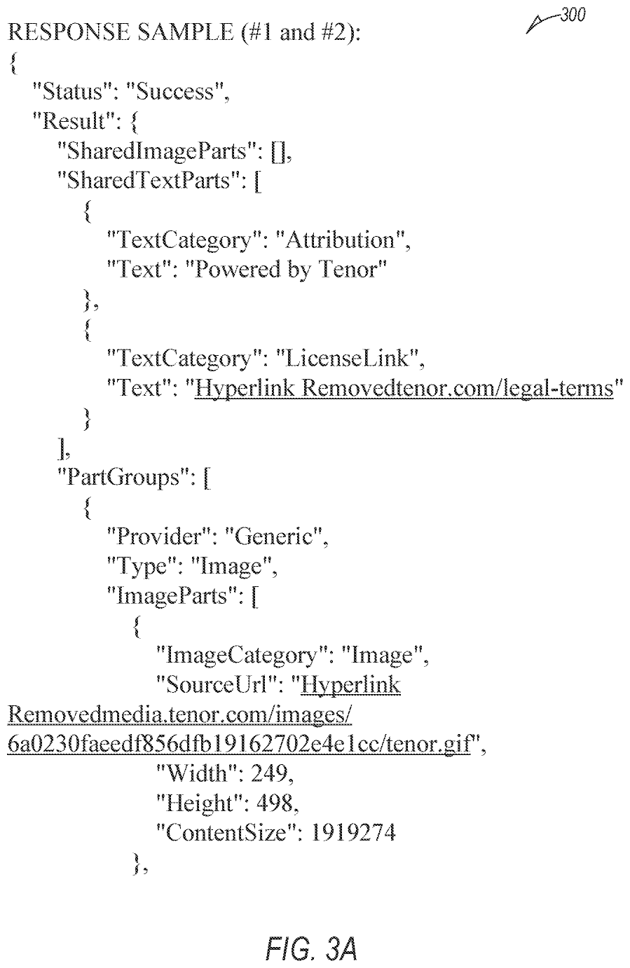

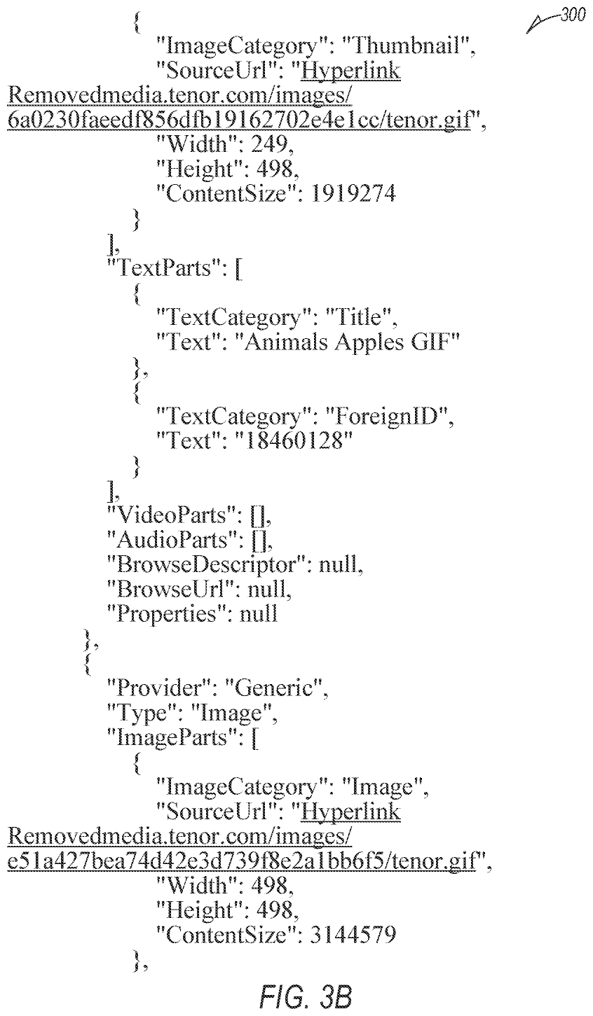

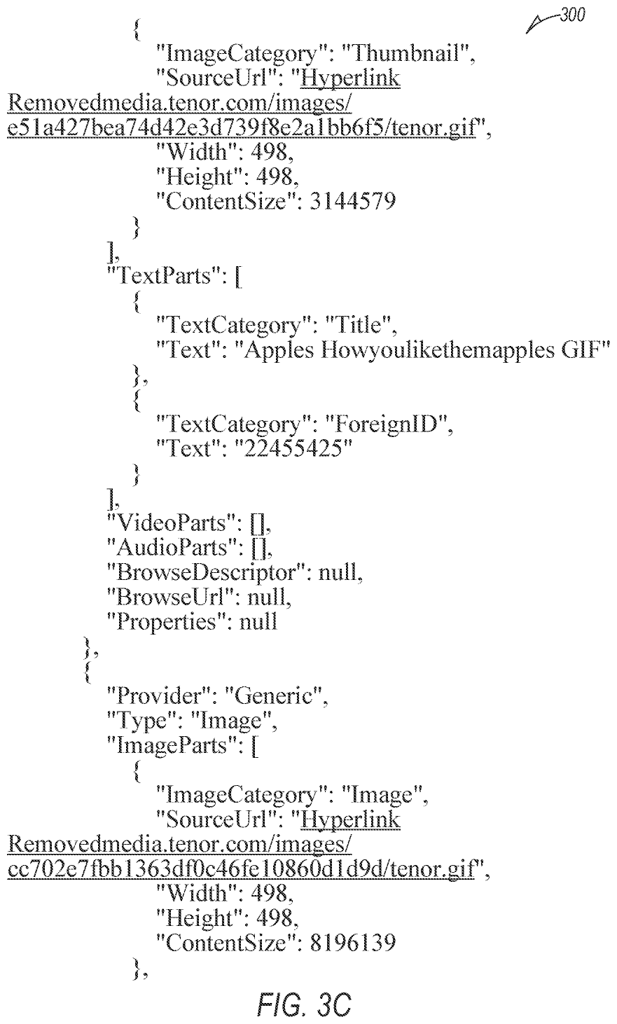

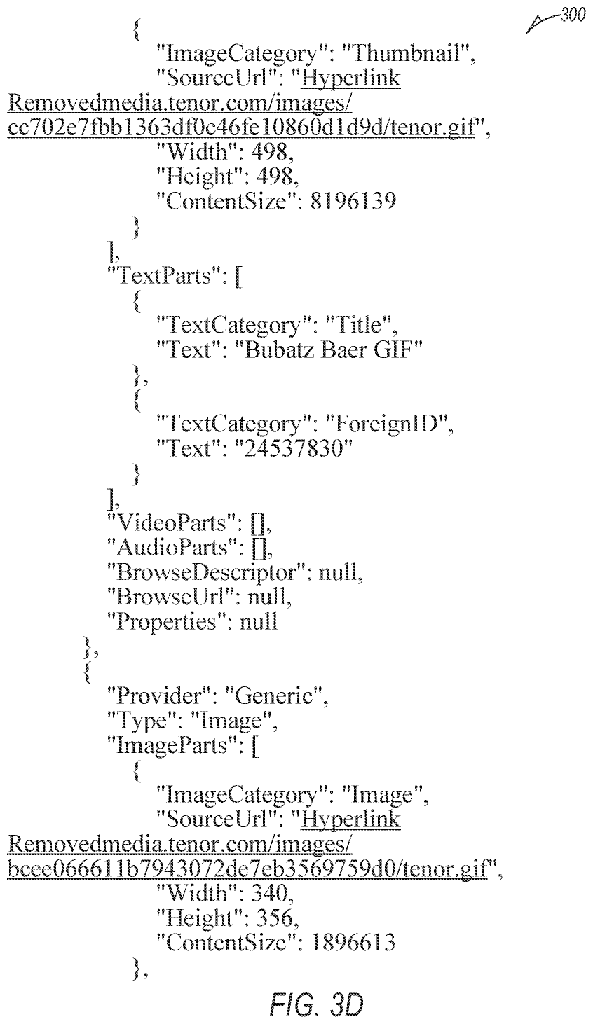

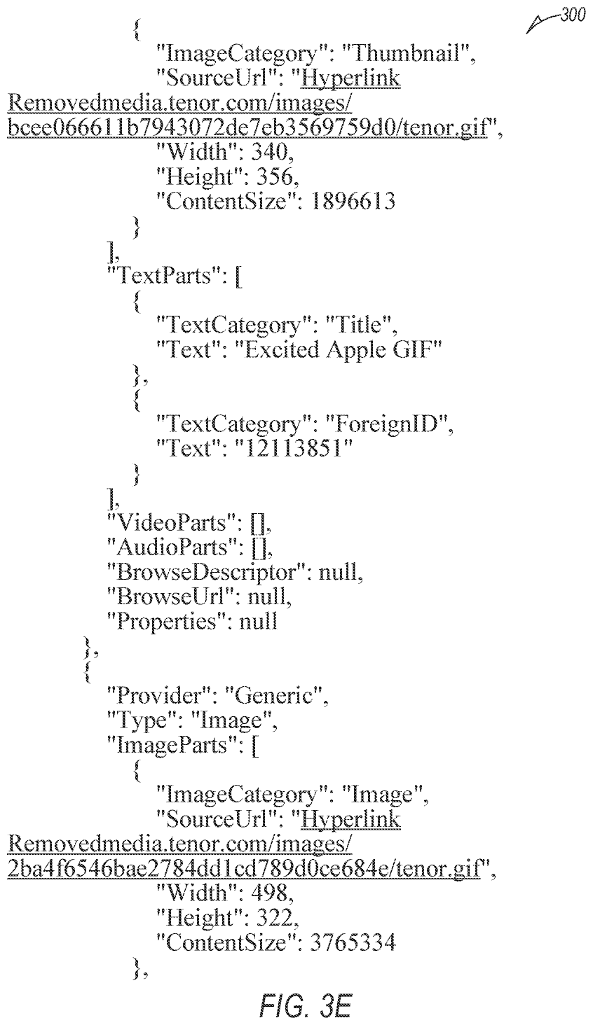

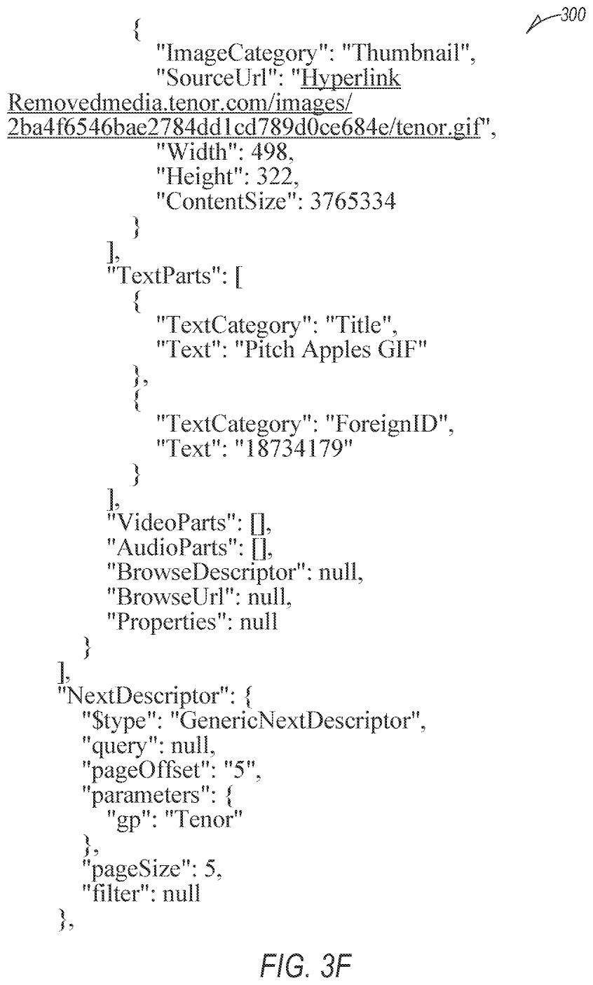

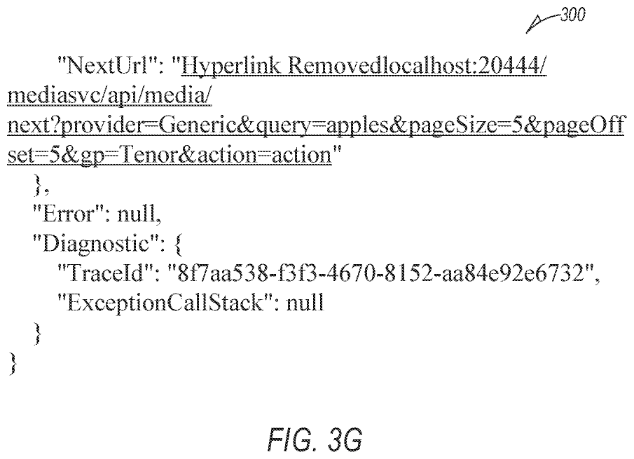

FIGS. 3A, 3B, 3C, 3D, 3E, 3F, and 3G placed end to end are a diagram illustrating an example response at 300. Response 300 corresponds to response 160 in FIG. 1 that may be returned for either one of the above search requests. Response 300 includes an attribution to Tenor, a link to a legal notice of Tenor, and 10 results that include links to the images that were found. A link to a URL with further results may also be included.

The response 300 from the provider will be formatted by parser 165 using the generic_response_parsing portion of the provider definition 140 or at 215 in request 200 depending on whether user device 125 or user device 175 issued the search request. The response will appear on each user device as a list of search results that have a uniform appearance. Thumbnail sizes and attributions, widths and heights of the various portions of the response are defined by the provider definition. In sonic instances, the generic_response_parsing portion may be used from the default provider definition from provider definitions 140.

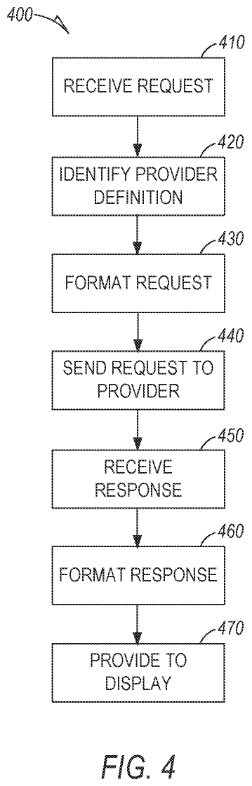

FIG. 4 is a flowchart illustrating a computer implemented method 400 of using provider definitions while searching disparate data sources. Method 400 begins at operation 410 by receiving a request for data to be retrieved from a first provider of multiple providers. A first provider definition data structure is identified at operation 420. The first provider definition data structure may be included in the first request in one example. In a further example, the first provider definition data structure may be identified and accessed from a list of multiple different provider definition data structures based on the identification of the first provider in the request for data.

The request for data is formatted at operation 430 in accordance with the first provider definition data structure to generate a first formatted request. At operation 440, the first formatted request is sent to the first provider. A first response is received from the first provider at operation 450. The first response may be formatted in accordance with the first provider definition data structure at operation 460 and provided at operation 470 for display on a user device that generated the request for data.

In one example, the request for data may identify additional providers to be searched. Each provider has a corresponding provider definition data structure, resulting in corresponding formatted requests and responses as is done to generate the first formatted request. Responses from the multiple providers may each be formatted in a similar manner and aggregated into a unified response structure for browsing on the client device.

In various examples, the first provider definition data structure identifies application programming interface (API) endpoints, response parsing details including a page size, and provider attribution. The first provider definition data structure may be a JSON or XML listing.

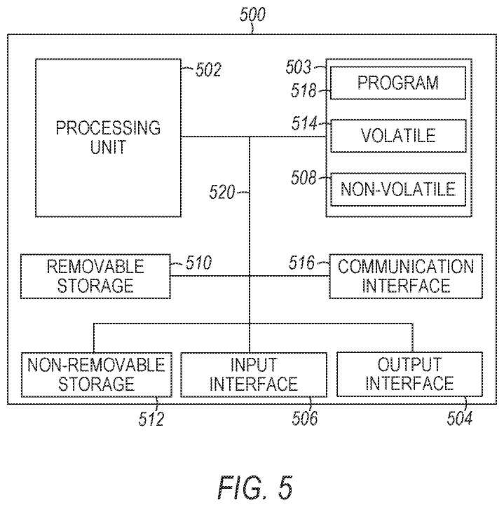

FIG. 5 is a block schematic diagram of a computer system 500 to format search requests and responses utilizing provider definition data structures and for performing other methods and algorithms according to example embodiments. All components need not be used in various embodiments.

One example computing device in the form of a computer 500 may include a processing unit 502, memory 503, removable storage 510, and non-removable storage 512. Although the example computing device is illustrated and described as computer 500, the computing device may be in different forms in different embodiments. For example, the computing device may instead be a smartphone, a tablet, smartwatch, smart storage device (SSD), or other computing device including the same or similar elements as illustrated and described with regard to FIG. 5. Devices, such as smartphones, tablets, and smartwatches, are generally collectively referred to as mobile devices or user equipment.

Although the various data storage elements are illustrated as part of the computer 500, the storage may also or alternatively include cloud-based storage accessible via a network, such as the Internet or server-based storage. Note also that an SSD may include a processor on which the parser may be run, allowing transfer of parsed, filtered data through channels between the SSD and main memory.

Memory 503 may include volatile memory 514 and non-volatile memory 508. Computer 500 may include—or have access to a computing environment that includes—a variety of computer-readable media, such as volatile memory 514 and non-volatile memory 508, removable storage 510 and non-removable storage 512. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 500 may include or have access to a computing environment that includes input interface 506, output interface 504, and a communication interface 516. Output interface 504 may include a display device, such as a touchscreen, that also may serve as an input device. The input interface 506 may include one or more of a touchscreen, touchpad, mouse, keyboard, camera, one or more device-specific buttons, one or more sensors integrated within or coupled via wired or wireless data connections to the computer 500, and other input devices. The computer may operate in a networked environment using a communication connection to connect to one or more remote computers, such as database servers. The remote computer may, include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 500 are connected with a system bus 520.

Computer-readable instructions stored on a computer-readable medium are executable by the processing unit 502 of the computer 500, such as a program 518. The program 518 in some embodiments comprises software to implement one or more methods described herein. A hard drive, CD-ROM, and RAM are some examples of articles including a non-transitory computer-readable medium such as a storage device. The terms computer-readable medium, machine readable medium, and storage device do not include carrier waves or signals to the extent carrier waves and signals are deemed too transitory. Storage can also include networked storage, such as a storage area network (SAN). Computer program 518 along with the workspace manager 522 may be used to cause processing unit 502 to perform one or more methods or algorithms described herein.

### EXAMPLES

1. A computer implemented method includes receiving a first request for data to be retrieved from a first provider of multiple providers. A first provider definition data structure is identified. The first request is then formatted in accordance with the first provider definition data structure to generate a first formatted request. The first formatted request is sent to the first provider and a first response is received from the first provider.

2. The method of example 1 and further comprising formatting the response in accordance with the first provider definition data structure.

3. The method of example 2 wherein the response is formatted into a unified view for display on a client device in response to the received request,

4. The method of any of examples 1-3 wherein the first provider definition data structure is received with the first request,

5. The method of any of examples 1-4 wherein the first request for data includes an identification of the first provider and wherein the first provider definition data structure is identified and accessed from a list of multiple different provider definition data structures based on the identification of the first provider.

6. The method of any of examples 1-5 wherein the first request identifies additional providers, each provider having a corresponding provider definition data structures resulting in corresponding formatted requests and responses.

7. The method of example 6 wherein the responses are aggregated into a unified response structure for browsing.

8. The method of any of examples 1-7 wherein the first provider definition data structure identifies application programming interface (API) endpoints.

9. The method of any of examples 1-8 wherein the first provider definition data structure identifies response parsing details including a page size.

10. The method of any of examples 1-9 wherein the first provider definition data structure identifies provider attribution.

11. The method of any of examples 1-10 wherein the first provider definition data structure includes a JSON or XML listing.

12. A machine-readable storage device having instructions for execution by a processor of a machine to cause the processor to perform operations to perform any of the methods of examples 1-11.

13. A device includes a processor and a memory device coupled to the processor and having a program stored thereon for execution by the processor to perform operations any of the methods of examples 1-11.

Although a few embodiments have been described in detail above, other modifications are possible. For example, the logic flows depicted in the figures do not require the particular order shown, or sequential order, to achieve desirable results, Other steps may be provided, or steps may be eliminated, from the described flows, and other components may be added to, or removed from, the described systems. Other embodiments may be within the scope of the following claims.

1. A computer implemented method comprising:
receiving a first request for data to be retrieved from a first provider of multiple providers;
identifying a first provider definition data structure;
formatting the first request in accordance with the first provider definition data structure to generate a first formatted request;
sending a first formatted request to the first provider; and
receiving a first response from the first provider.

2. The method of claim 1 and further comprising formatting the response in accordance with the first provider definition data structure. The method of claim 2 wherein the response is formatted into a unified view for display on a client device in response to the received request.

4. The method of claim 1 wherein the first provider definition data structure is received with the first request.

5. The method of claim 1 wherein the first request for data includes an identification of the first provider and wherein the first provider definition data structure is identified and accessed from a list of multiple different provider definition data structures based on the identification of the first provider.

6. The method of claim 1 wherein the first request identifies additional providers, each provider having a corresponding provider definition data structures resulting in corresponding formatted requests and responses.

7. The method of claim 6 wherein the responses are aggregated into a unified response structure for browsing.

8. The method of claim 1 wherein the first provider definition data structure identifies application programming interface (API) endpoints.

9. The method of claim 1 wherein the first provider definition data structure identifies response parsing details including a page size,

10. The method of claim 1 wherein the first provider definition data structure identifies provider attribution.

11. The method of claim 1 wherein the first provider definition data structure is comprises a JSON or XML listing.

12. A machine-readable storage device having instructions for execution by a processor of a machine to cause the processor to perform operations to perform a method, the operations comprising:
receiving a first request for data to be retrieved from a first provider of multiple providers;
identifying a first provider definition data structure;
formatting the first request in accordance with the first provider definition data structure to generate a first formatted request;
sending a first formatted request to the first provider; and
receiving a first response from the first provider.

13. The device of claim 12 and further comprising formatting the response in accordance with the first provider definition data structure.

14. The device of claim 13 wherein the response is formatted into a unified view for display on a client device in response to the received request.

15. The device of claim 12 wherein the first provider definition data structure is received with the first request.

16. The device of claim 12 wherein the first request for data includes an identification of the first provider and wherein the first provider definition data structure is identified and accessed from a list of multiple different provider definition data structures based on the identification of the first provider.

17. The device of claim 12 wherein the first request identifies additional providers, each provider having a corresponding provider definition data structures resulting in corresponding formatted requests and responses.

18. The device of claim 17 wherein the responses are aggregated into a unified response structure for browsing.

19. The device of claim 12 wherein the first provider definition data structure. identifies application programming interface (API) endpoints, response parsing details including a page size, and provider attribution.

20. A device comprising:
a processor; and
a memory device coupled to the processor and having a program stored thereon for execution by the processor to perform operations comprising:
receiving a first request for data to be retrieved from a first provider of multiple providers;
identifying a first provider definition data structure;
formatting the first request in accordance with the first provider definition data structure to generate a first formatted request;
sending a first formatted request to the first provider; and
receiving a first response from the first provider.
